(19) United States
(12) Patent Application Publication
(10) Pub. No.: US 2026/0238415 A1
(43) Pub. Date: Aug. 13, 2026

(54) METHOD AND APPARATUS FOR TRANSMITTING AND RECEIVING UPLINK IN WIRELESS COMMUNICATION SYSTEM

(71) Applicant: LG Electronics Inc., Seoul (KR)

(72) Inventors: Choongsang BAN, Seoul (KR); Seokmin SHIN, Seoul (KR); Suckchel YANG, Seoul (KR); Duckhyun BAE, Seoul (KR)

(21) Appl. No.: 19/156,651

(22) PCT Filed: Feb. 14, 2024
(86) PCT No.: PCT/KR2024/002071

§ 371 Date: Aug. 14, 2025

(30) Foreign Application Priority Data
Feb. 14, 2023 (KR) 10-2023-0019515

(51) Int. Cl. H04L 5/00; H04B 7/0456; H04L 27/26; H04W 74/0833

(52) U.S. Cl. CPC H04L 5/0044; H04B 7/0456; H04L 27/2636; H04W 74/0833

(57) ABSTRACT

A method according to an embodiment of the present disclosure incudes receiving configuration information related to PUSCH, receiving DCI for scheduling the PUSCH, and transmitting the PUSCH. Based on a DCI format related to the DCI and/or the configuration information, whether a transform precoding for the PUSCH is enabled is determined based on the DCI or a higher layer parameter.

### TECHNICAL FIELD

The present disclosure relates to a method and an apparatus for transmitting and receiving an uplink in a wireless communication system.

### BACKGROUND ART

Mobile communication systems have been developed to provide a voice service while ensuring the activity of a user. However, in the mobile communication system, not only a voice, but also a data service is extended. At present, there is a shortage of resources due to an explosive increase in traffic, and users demand a higher speed service. As a result, a more advanced mobile communication system is required.

Requirements for a next-generation mobile communication system should be able to support the acceptance of explosive data traffic, a dramatic increase in the per-user data rate, the acceptance of a significant increase in the number of connected devices, very low end-to-end latency, and high-energy efficiency. To this end, various technologies are researched, which include dual connectivity, massive multiple input multiple output (MIMO), in-band full duplex, non-orthogonal multiple access (NOMA), super wideband support, device networking, and the like.

On the other hand, according to an existing operation, a UL waveform is configured semi-statically. The UL waveform may vary based on whether transform precoding is applied/whether the transform precoding is enabled. Hereinafter, this will be specifically described.

1) When the transform precoding is applied (that is, when the transform precoding is enabled), the waveform is based on Discrete Fourier Transform-spreading-Orthogonal Frequency Division Multiplexing (DFT-s-OFDM).

2) When the transform precoding is not applied (that is, when the transform precoding is disabled), the waveform is based on Cyclic Prefix-Orthogonal Frequency Division Multiplexing (CP-OFDM).

Whether the transform precoding is enabled is configured/indicated semi-statically.

For example, whether the transform precoding is enabled may be determined based on an RRC parameter. i) When a transformPrecoder parameter is configured based on PUSCH-config, whether the transform precoding is enabled may be determined based on the transformPrecoder parameter. ii) When the transformPrecoder parameter is not configured, whether the transform precoding is enabled may be determined based on an msg3-transformPrecoder parameter.

According to Rel-18 coverage enhancement, a dynamic waveform switching operation related to the above-described UL waveform is supported. As dynamic waveform switching operation is supported, ambiguity in terminal operation may occur. For example, operations i) and ii) below may be assumed.

i) An UL waveform related indication (an enable/disable related indication of the transform precoding) may be performed based on each of RRC signaling and dynamic signaling (e.g., DCI). Specifically, the transform precoding is configured to be enabled (or disabled) through the RRC signaling, but the transform precoding may be configured to be disabled (or enabled) through the dynamic signaling. That is, for conflicting configurations/indications, it may be ambiguous which configuration/indication the terminal is to prioritize.

ii) The UL waveform related indication (the enable/disable related indication of the transform precoding) may be performed based on the RRC signaling. As the dynamic waveform switching is supported, the terminal expects to receive a dynamic indication for determination of the UL waveform from the base station. However, when there is no dynamic indication as in ii), it may be ambiguous how the terminal is to operate. As a specific example, it may be ambiguous whether the terminal should operate based on an indication via the corresponding RRC signaling or based on a waveform indication (an indication of whether the transform precoding is enabled) via previous scheduling DCI.

### DETAILED DESCRIPTION OF INVENTION

### Technical Problems

As described above, ambiguity in terminal operation may occur due to the newly supported dynamic waveform switching operation.

An object of the present disclosure is to provide a method for solving the above-described problems.

The technical objects to be achieved by the present disclosure are not limited to those that have been described hereinabove merely by way of example, and other technical objects that are not mentioned can be clearly understood by those skilled in the art, to which the present disclosure pertains, from the following descriptions.

### Technical Solution

A method performed by a user equipment in a wireless communication system according to an embodiment of the present disclosure comprises receiving configuration information related to a Physical Uplink Shared Channel (PUSCH), receiving Downlink Control Information (DCI) for scheduling of the PUSCH, and transmitting the PUSCH.

Based on a DCI format related to the DCI and/or the configuration information, whether a transform precoding for the PUSCH is enabled is determined based on the DCI or a higher layer parameter.

Based on the DCI format being a DCI format 0_1 or a DCI format 0_2 and a parameter related to a dynamic indication of the transform precoding being configured based on the configuration information: the DCI includes a transform precoder indicator field, and the transform precoding is enabled or disabled based on the transform precoder indicator field.

Based on the DCI format being the DCI format 0_1 or the DCI format 0_2, and the parameter related to the dynamic indication not being configured based on the configuration information: the transform precoding may be enabled or disabled based on the higher layer parameter.

The higher layer parameter may be a transformPrecoder parameter within the configuration information or a random access parameter.

Based on the transformPrecoder parameter not being configured: the transform precoding may be enabled or disabled based on the random access parameter.

The random access parameter may be an msg3-transformPrecoder parameter.

Based on the DCI format being a DCI format 0_0, the transform precoding may be enabled or disabled based on the higher layer parameter.

Based on a txConfig parameter representing a transmission scheme related to the PUSCH not being configured, the DCI format may be the DCI format 0_0.

The PUSCH may be transmitted based on a single antenna port.

Based on the txConfig parameter representing a transmission scheme related to the PUSCH being configured, the DCI format may be the DCI format 0_1 or the DCI format 0_2.

The transmission scheme may be codebook based transmission or non-codebook based transmission.

The PUSCH may be transmitted based on same antenna ports as one or more SRS ports indicated based on the DCI format.

The one or more SRS ports may be based on one or more SRS resources indicated based on an SRS resource indicator field of the DCI format.

A waveform related to the transmission of the PUSCH may be based on i) Cyclic Prefix-Orthogonal Frequency Division Multiplexing (CP-OFDM) or ii) Discrete Fourier Transform-Spreading-OFDM (DFT-S-OFDM).

The transform precoding may be related to the DFT-S-OFDM.

Physical Uplink Control Information (UCI) may be multiplexed in the PUSCH in which the transform precoding is enabled based on the transform precoder indicator field. A Physical Uplink Control Channel (PUCCH) format related to the UCI may be PUCCH format 3 or PUCCH format 4. The transform precoding may be applied to the PUCCH format 3 or the PUCCH format 4.

The method may further comprise transmitting a Physical Uplink Control Channel (PUCCH). The PUSCH and the PUCCH may be transmitted simultaneously.

A waveform related to the PUSCH may be the same as a waveform related to the PUCCH.

The waveform related to the PUSCH may be different from the waveform related to the PUCCH.

A user equipment (UE) operating in a wireless communication according to another embodiment of the present disclosure comprises one or more transceivers, one or more processors, and one or more memories connected to the one or more processors and configured to store instructions.

The instructions, based on being executed by the one or more processors, configure the one or more processors to perform all steps of any one of the methods.

A device according to another embodiment of the present disclosure comprises one or more memories and one or more processors operably connected to the one or more memories.

The one or more memories are configured to store instructions based on being executed by the one or more processors, and the instructions are configured to allow the one or more processors to perform all steps of any one of the methods.

One or more non-transitory computer readable mediums according to another embodiment of the present disclosure stores instructions.

The instructions executable by one or more processors are configured to allow the one or more processors to perform all steps of any one of the methods.

A method performed by a base station in a wireless communication system according to another embodiment of the present disclosure comprises transmitting configuration information related to a Physical Uplink Shared Channel (PUSCH), transmitting Downlink Control Information (DCI) for scheduling of the PUSCH, and receiving the PUSCH.

Based on a DCI format related to the DCI and/or the configuration information: whether a transform precoding for the PUSCH is enabled is determined based on the DCI or a higher layer parameter.

Based on the DCI format being a DCI format 0_1 or a DCI format 0_2 and a parameter related to a dynamic indication of the transform precoding being configured based on the configuration information: the DCI includes a transform precoder indicator field, and the transform precoding is enabled or disabled based on the transform precoder indicator field.

A base station operating in a wireless communication according to another embodiment of the present disclosure comprises one or more transceivers, one or more processors, and one or more memories connected to the one or more processors and configured to store instructions.

The instructions, based on being executed by the one or more processors, are configured to allow the one or more processors to perform all steps of any one of the methods.

### Advantageous Effects

According to an embodiment of the present disclosure, based on a DCI format and/or configuration information related to DCI: whether transform precoding for a PUSCH is enabled is determined based on the DCI or a higher layer parameter. Therefore, a case where whether transform precoding is applied dynamically is indicated through the DCI is clearly defined/configured. An ambiguity in terminal operation related to whether the transform precoding is applied during PUSCH transmission scheduled by the DCI may be resolved.

In addition, since a case where whether the transform precoding is applied is dynamically indicated is clearly defined, it may be expected that the dynamic waveform switching operation is accurately performed by the terminal that receives the dynamic indication. Accordingly, an effectiveness of the dynamic waveform switching operation introduced for utilization of a waveform more suitable for a channel environment may be ensured.

Effects that could be achieved with the present disclosure are not limited to those that have been described hereinabove merely by way of example, and other effects and advantages of the present disclosure will be more clearly understood from the following description by a person skilled in the art to which the present disclosure pertains.

### BRIEF DESCRIPTION OF THE DRAWING

FIG. 1 illustrates an example of an uplink transmission/reception operation.

FIG. 2 is a flowchart illustrating a method performed by a user equipment according to an embodiment of the present disclosure.

FIG. 3 is a flowchart illustrating a method performed by a base station according to another embodiment of the present disclosure.

FIG. 4 illustrates configurations of a first device and a second device according to an embodiment of the present disclosure.

### DETAILED DESCRIPTION

Reference will now be made in detail to embodiments of the present disclosure, examples of which are illustrated in the accompanying drawings. A detailed description to be disclosed below together with the accompanying drawing is to describe exemplary embodiments of the present disclosure and not to describe a unique embodiment for carrying out the present disclosure. The detailed description below includes details to provide a complete understanding of the present disclosure. However, those skilled in the art know that the present disclosure may be carried out without the details.

In some cases, in order to prevent a concept of the present disclosure from being ambiguous, known structures and devices may be omitted or illustrated in a block diagram format based on core functions of each structure and device.

Hereinafter, downlink (DL) means communication from the base station to the terminal and uplink (UL) means communication from the terminal to the base station. In downlink, a transmitter may be part of the base station, and a receiver may be part of the terminal. In uplink, the transmitter may be part of the terminal and the receiver may be part of the base station. The base station may be expressed as a first communication device and the terminal may be expressed as a second communication device. A base station (BS) may be replaced with terms including a fixed station, a Node B, an evolved-NodeB (eNB), a Next Generation NodeB (gNB), a base transceiver system (BTS), an access point (AP), a network (5G network), an AI system, a road side unit (RSU), a vehicle, a robot, an Unmanned Aerial Vehicle (UAV), an Augmented Reality (AR) device, a Virtual Reality (VR) device, and the like. Further, the terminal may be fixed or mobile and may be replaced with terms including a User Equipment (UE), a Mobile Station (MS), a user terminal (UT), a Mobile Subscriber Station (MSS), a Subscriber Station (SS), an Advanced Mobile Station (AMS), a Wireless Terminal (WT), a Machine-Type Communication (MTC) device, a Machine-to-Machine (M2M) device, and a Device-to-Device (D2D) device, the vehicle, the robot, an AI module, the Unmanned Aerial Vehicle (UAV), the Augmented Reality (AR) device, the Virtual Reality (VR) device, and the like.

### Uplink Channel Structure

The UE transmits a related signal to the base station through an uplink channel to be described below and the base station receives the related signal from the UE through the uplink channel to be described below.

### (1) Physical Uplink Shared Channel (PUSCH)

The PUSCH transports uplink data (e.g., UL-shared channel transport block (UL-SCH TB) and/or uplink control information (UCI) and is transmitted based on a Cyclic Prefix—Orthogonal Frequency Division Multiplexing (CP-OFDM) waveform or a Discrete Fourier Transform—spread—Orthogonal Frequency Division Multiplexing (DFT-s-OFDM) waveform. When the PUSCH is transmitted based on the DFT-s-OFDM waveform, the UE transmits the PUSCH by applying transform precoding. As an example, when the transform precoding is disable (e.g., transform precoding is disabled), the UE transmits the PUSCH based on the CP-OFDM waveform, and when the transform precoding is enabled (e.g., transform precoding is enabled), the UE may transmit the PUSCH based on the CP-OFDM waveform or the DFT-s-OFDM waveform. PUSCH transmission is dynamically scheduled by the UL grant in the DC or semi-statically scheduled based on higher layer (e.g., RRC) signaling (and/or Layer 1 (LI) signaling (e.g., PDCCH)) (configured grant). The PUSCH transmission may be performed based on a codebook or a non-codebook.

### (2) Physical Uplink Control Channel (PUCCH)

The PUCCH transports uplink control information, HARQ-ACK, and/or scheduling request (SR), and is divided into Short PUCCH and Long PUCCH according to a PUCCH transmission length. Table 1 shows PUCCH formats.

TABLE 1

| | Length in OFDM | | | |
|---|---|---|---|---|
| PUCCH format | $symbols {N}_{symb}^{PUCCH}$ | Number of bits | Usage | Etc |
| 0 | 1-2 | ≤2 | HARQ, SR | Sequence selection |
| 1 | 4-14 | ≤2 | HARQ, [SR] | Sequence modulation |
| 2 | 1-2 | >2 | HARQ, CSI, [SR] | CP-OFDM |
| 3 | 4-14 | >2 | HARQ, CSI, [SR] | DFT-s-OFDM |
| | | | | (no UE |
| | | | | multiplexing) |
| 4 | 4-14 | >2 | HARQ, CSI, [SR] | DFT-s-OFDM |
| | | | | (Pre DFT OCC) |

PUCCH format 0 transports UCI with a maximum size of 2 bits and is mapped and transmitted based on a sequence. Specifically, the UE transmits specific UCI to the base station by transmitting one of a plurality of sequences through the PUCCH which is PUCCH format 0. The UE transmits the PUCCH which is PUCCH format 0 within a PUCCH resource for configuring a corresponding SR only when transmitting a positive SR.

PUCCH format 1 transports the UCI having the maximum size of 2 bits and the modulation signal is spread by an orthogonal cover code (OCC)(configured differently depending on whether frequency hopping is made) in the time domain. The DMRS is transmitted in a symbol in which the modulation symbol is not transmitted (that is, time division multiplexed (TDMed) and transmitted).

PUCCH format 2 transports UCI having a bit size larger than 2 bits and the modulation symbol is frequency division multiplexed (FDMed) with the DMRS and transmitted. The DM-RS is located in symbol indexes #1, #4, #7, and #10 within a resource block given with a density of ⅓. A pseudo noise (PN) sequence is used for a DM_RS sequence. The frequency hopping may be activated for 2 symbol PUCCH format 2.

PUCCH format 3 is not subjected to UE-multiplexing within the same physical resource blocks, and transports UCI with a bit size larger than 2 bits. In other words the PUCCH resource of PUCCH format 3 does not include the orthogonal cover code. The modulation symbol time division multiplexed (TDMed) with the DMRS and transmitted.

PUCCH format 4 supports multiplexing of up to 4 UEs in the same physical resource blocks, and transports the UCI with the bit size larger than 2 bits. In other words the PUCCH resource of PUCCH format 3 includes the orthogonal cover code. The modulation symbol is time division multiplexed (TDMed) with the DMRS and transmitted.

### Uplink Transmission/Reception Operation

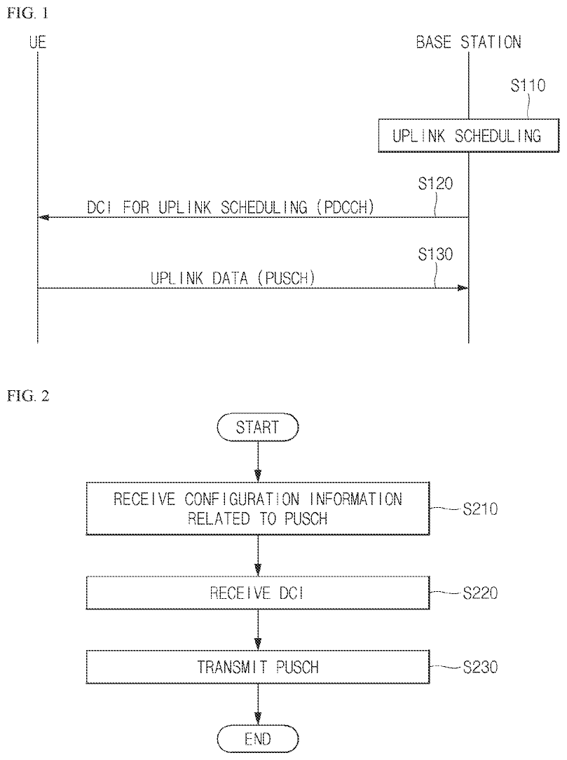

FIG. 1 illustrates an example of an uplink transmission and reception operation. Referring to the FIG. 1, the eNB may schedule uplink transmission such as the frequency/time resource, the transport layer, an uplink precoder, the MCS, etc., (S110). In particular, the eNB may determine a beam for PUSCH transmission of the UE through the beam management operations described above. And, the UE may receive, from the eNB. DCI for uplink scheduling (i.e., including scheduling information of the PUSCH) on the PDCCH (S120).

DCI format 0_0 or 0_1 may be used for the uplink scheduling and in particular, DCI format 0_1 may include information such as the following examples: Identifier for DCI formats. UL/Supplementary uplink (SUL) indicator, Bandwidth part indicator, Frequency domain resource assignment. Time domain resource assignment, Frequency hopping flag, Modulation and coding scheme (MCS), SRS resource indicator (SRI), Precoding information and number of layers, Antenna port(s), SRS request, DMRS sequence initialization, and Uplink Shared Channel (UL-SCH) indicator.

In particular, configured SRS resources in an SRS resource set associated with higher layer parameter “usage” may be indicated by an SRS resource indicator field. Further. “spatialRelationinfo” may be configured for each SRS resource and a value of “spatialRelationlnfo” may be one of (CRI, SSB, and SRI).

In addition, the UE may transmit the uplink data to the eNB on the PUSCH (S130). When the UE detects a PDCCH including DCI format 0_0 or 0_1, the UE may transmit the corresponding PUSCH according to the indication by the corresponding DCI. two schemes (Codebook based transmission scheme and non-codebook based transmission scheme) are supported for PUSCH transmission.

In the case of the codebook based transmission, when higher layer parameter txConfig” is set to “codebook”, the UE is configured to the codebook based transmission. On the contrary, when higher layer parameter txConfig” is set to “nonCodebook”, the UE is configured to the non-codebook based transmission. When higher layer parameter “txConfig” is not configured, the UE does not predict that the PUSCH is scheduled by DCI format 0_1. When the PUSCH is scheduled by DCI format 0_0, the PUSCH transmission is based on a single antenna port. In the case of the codebook based transmission, the PUSCH may be scheduled by DCI format 0_0, DCI format 0_1, or semi-statically. When the PUSCH is scheduled by DCI format 0_1, the UE determines a PUSCH transmission precoder based on the SRI, the Transmit Precoding Matrix Indicator (TPMI), and the transmission rank from the DCI as given by the SRS resource indicator and the Precoding information and number of layers field. The TPMI is used for indicating a precoder to be applied over the antenna port and when multiple SRS resources are configured, the TPMI corresponds to the SRS resource selected by the SRI. Alternatively, when the single SRS resource is configured, the TPMI is used for indicating the precoder to be applied over the antenna port and corresponds to the corresponding single SRS resource. A transmission precoder is selected from an uplink codebook having the same antenna port number as higher layer parameter “nrofSRS-Ports”. When the UE is set to higher layer parameter “txConfig” set to “codebook”, at least one SRS resource is configured in the UE. An SRI indicated in slot n is associated with most recent transmission of the SRS resource identified by the SRI and here, the SRS resource precedes PDCCH (i.e., slot n) carrying the SRI.

In the case of the non-codebook based transmission, the PUSCH may be scheduled by DCI format 0_0, DCI format 0_1, or semi-statically. When multiple SRS resources are configured, the UE may determine the PUSCH precoder and the transmission rank based on a wideband SRI and here, the SRI is given by the SRS resource indicator in the DCI or given by higher layer parameter “srs-Resourcelndicator”. The UE may use one or multiple SRS resources for SRS transmission and here, the number of SRS resources may be configured for simultaneous transmission in the same RB based on the UE capability. Only one SRS port is configured for each SRS resource. Only one SRS resource may be configured to higher layer parameter “usage” set to “nonCodebook”. The maximum number of SRS resources which may be configured for non-codebook based uplink transmission is 4. The SRI indicated in slot n is associated with most recent transmission of the SRS resource identified by the SRI and here, the SRS transmission precedes PDCCH (i.e., slot n) carrying the SRI.

Transform Precoder field

Hereinafter, a configuration related to the transform precoder which may be applied to embodiments to be described below will be described.

TABLE 2
RACH-ConfigCommon
The IE RACH-ConfigCommon is used to specify the cell specific random-access
parameters.
RACH-ConfigCommon information element
-- ASN1START
-- TAG-RACH-CONFIGCOMMON-START

| | |
|---|---|
| RACH-ConfigCommon ::= | SEQUENCE { |
| rach-ConfigGeneric | RACH-ConfigGeneric, |
| totalNumberOfRA-Preambles | INTEGER (1..63) |

OPTIONAL, -- Need S

| | |
|---|---|
| ssb-perRACH-OccasionAndCB-PreamblesPerSSB | CHOICE { |
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED |

{n4,n8,n12,n16,n20,n24,n28,n32},

| | |
|---|---|
| four | INTEGER (1..16), |
| eight | INTEGER (1..8), |
| sixteen | INTEGER (1..4) |

}
OPTIONAL, -- Need M

| | |
|---|---|
| groupBconfigured | SEQUENCE { |
| ra-Msg3SizeGroupA | ENUMERATED {b56, |

b144, b208, b256, b282, b480, b640,

b800,

b1000, b72, spare6, spare5,spare4, spare3, spare2, spare1},

| | |
|---|---|
| messagePowerOffsetGroupB | ENUMERATED |

{ minusinfinity, dB0, dB5, dB8, dB10, dB12, dB15, dB18},

| | |
|---|---|
| numberOfRA-PreamblesGroupA | INTEGER (1..64) |

}
OPTIONAL, -- Need R

| | |
|---|---|
| ra-ContentionResolutionTimer | ENUMERATED { sf8, sf16, |

sf24, sf32, sf40, sf48, sf56, sf64},

| | |
|---|---|
| rsrp-ThresholdSSB | RSRP-Range |

OPTIONAL, -- Need R

| | |
|---|---|
| rsrp-ThresholdSSB-SUL | RSRP-Range |

OPTIONAL, -- Cond SUL

| | |
|---|---|
| prach-RootSequenceIndex | CHOICE { |

| | |
|---|---|
| l839 | INTEGER (0..837), |
| l139 | INTEGER (0..137) |

},

| | |
|---|---|
| msg1-SubcarrierSpacing | SubcarrierSpacing |

OPTIONAL, - Cond L139

| | |
|---|---|
| restrictedSetConfig | ENUMERATED |

{unrestrictedSet, restrictedSetTypeA, restrictedSetTypeB},

| | |
|---|---|
| msg3-transformPrecoder | ENUMERATED {enabled} |

```
OPTIONAL, -- Need R
  ...,
  [[
```

| | |
|---|---|
| ra-PrioritizationForAccessIdentity-r16 | SEQUENCE { |
| ra-Prioritization-r16 | RA-Prioritization, |
| ra-PrioritizationForAI-r16 | BIT STRING (SIZE (2)) |

}
OPTIONAL, -- Cond InitialBWP-Only

| | |
|---|---|
| prach-RootSequenceIndex-r16 | CHOICE { |

| | |
|---|---|
| l571 | INTEGER (0..569), |
| l1151 | INTEGER (0..1149) |

```
  }  OPTIONAL -- Need R
  ]],
  [[
```

| | |
|---|---|
| ra-PrioritizationForSlicing-r17 | RA-PrioritizationForSlicing-r17 |

```
OPTIONAL, -- Cond InitialBWP-Only
  featureCombinationPreambles-r17 SEQUENCE
(SIZE(1..maxFeatureCombPreambles-FFS-r17)) OF
FeatureCombinationPreambles-r17 OPTIONAL -- Need R
  ]]
-- Editor's Note: FFS where to implement CE-specific RACH-related parameters,
e.g. numberOfMsg3Repetitions, mcs-Msg3Repetition, is pending to RA
partitioning conclusion on the structure
}
AdditionalRACH-ConfigCommon-r17 ::= SEQUENCE {
```

| | |
|---|---|
| rach-ConfigCommon-r17 | RACH-ConfigCommon |

OPTIONAL, -- Need R

| | |
|---|---|
| msgA-ConfigCommon-r17 | MsgA-ConfigCommon-r16 |

OPTIONAL, -- Cond R
...
}

RACH-ConfigCommon field descriptions
featureCombinationPreambles
Specifies a series of preamble partitions each associated to a combination of
features and 4-step RA.
messagePowerOffsetGroupB
Threshold for preamble selection. Value is in dB. Value minusinfinity
corresponds to −infinity. Value dB0 corresponds to 0 dB, dB5 corresponds to 5
dB and so on. (see TS 38.321 [3], clause 5.1.2)
msg1-SubcarrierSpacing
Subcarrier spacing of PRACH (see TS 38.211 [16], clause 5.3.2).
Only the following values are applicable depending on the used frequency:
FR1: 15 or 30 kHz
FR2-1: 60 or 120 kHz
FR2-2: 120, 480, or 960 kHz
If absent, the UE applies the SCS as derived from the prach-
ConfigurationIndex in RACH-ConfigGeneric (see tables Table 6.3.3.1-1,
Table 6.3.3.1-2, Table 6.3.3.2-2 and Table 6.3.3.2-3. TS 38.211 [16]). The
value also applies to contention free random access (RACH-ConfigDedicated),
to SI-request and to contention-based beam failure recovery (CB-BFR). But it
does not apply for contention free beam failure recovery (CF-BFR) (see
BeamFailureRecoveryConfig).
msg3-transformPrecoder
Enables the transform precoder for Msg3 transmission according to clause
6.1.3 of TS 38.214 [19]. If the field is absent, the UE disables the transformer
precoder (see TS 38.213 [13], clause 8.3).
numberOfRA-PreamblesGroupA
The number of CB preambles per SSB in group A. This determines implicitly
the number of CB preambles per SSB available in group B. (see TS 38.321
[3], clause 5.1.1). The setting should be consistent with the setting of ssb-
perRACH-OccasionAndCB-PreamblesPerSSB.
prach-RootSequenceIndex
PRACH root sequence index (see TS 38.211 [16], clause 6.3.3.1). The value
range depends on whether L = 839 or L = 139 or L = 571 or L = 1151. The length
of the root sequence corresponding with the index indicated in this IE should
be consistent with the one indicated in prach-ConfigurationIndex in the
RACH-ConfigDedicated (if configured). If prach-RootSequenceIndex-r16 is
signalled, UE shall ignore the prach-RootSequenceIndex (without suffix).
For FR2-2, only the following values are applicable depending on the used
subcarrier spacing:
120 kHz: L = 139, L = 571, and L = 1151
480 kHz: L = 139, and L = 571
960 kHz: L = 139
ra-ContentionResolutionTimer
The initial value for the contention resolution timer (see TS 38.321 [3], clause
5.1.5). Value sf8 corresponds to 8 subframes, value sf16 corresponds to 16
subframes, and so on.
ra-Msg3SizeGroupA
Transport Blocks size threshold in bits below which the UE shall use a
contention-based RA preamble of group A. (see TS 38.321 [3], clause 5.1.2).
ra-Prioritization
Parameters which apply for prioritized random access procedure on any UL
BWP of SpCell for specific Access Identities (see TS 38.321 [3], clause
5.1.1a).
ra-PrioritizationForAI
Indicates whether the field ra-Prioritization-r16 applies for Access Identities.
The first/leftmost bit corresponds to Access Identity 1, the next bit
corresponds to Access Identity 2. Value 1 indicates that the field ra-
Prioritization-r16 applies otherwise the field does not apply (see TS 23.501
[32]).
rach-ConfigGeneric
RACH parameters for both regular random access and beam failure recovery.
restrictedSetConfig
Configuration of an unrestricted set or one of two types of restricted sets, see
TS 38.211 [16], clause 6.3.3.1
rsrp-ThresholdSSB
UE may select the SS block and corresponding PRACH resource for path-loss
estimation and (re)transmission based on SS blocks that satisfy the threshold
(see TS 38.213 [13]).
rsrp-ThresholdSSB-SUL
The UE selects SUL carrier to perform random access based on this threshold
(see TS 38.321 [3], clause 5.1.1). The value applies to all the BWPs.
ssb-perRACH-OccasionAndCB-PreamblesPerSSB
The meaning of this field is twofold: the CHOICE conveys the information
about the number of SSBs per RACH occasion. Value oneEighth corresponds
to one SSB associated with 8 RACH occasions, value oneFourth corresponds
to one SSB associated with 4 RACH occasions, and so on. The
ENUMERATED part indicates the number of Contention Based preambles
per SSB. Value n4 corresponds to 4 Contention Based preambles per SSB,
value n8 corresponds to 8 Contention Based preambles per SSB, and so on.
The total number of CB preambles in a RACH occasion is given by CB-
preambles-per-SSB * max(1, SSB-per-rach-occasion). See TS 38.213 [13].
totalNumberOfRA-Preambles
Total number of preambles used for contention based and contention free 4-
step or 2-step random access in the RACH resources defined in RACH-
ConfigCommon, excluding preambles used for other purposes (e.g. for SI
request). If the field is absent, all 64 preambles are available for RA. The
setting should be consistent with the setting of ssb-perRACH-
OccasionAndCB-PreamblesPerSSB, i.e. it should be a multiple of the number
of SSBs per RACH occasion.

Referring to Table 2, RACH-ConfigCommon includes an msg3-transformPrecoder parameter.

TABLE 3
MsgA-PUSCH-Config
The IE MsgA-PUSCH-Config is used to specify the PUSCH allocation for MsgA
in 2-step random access type procedure.
MsgA-PUSCH-Config information element
-- ASN1START
-- TAG-MSGA-PUSCH-CONFIG-START

| | |
|---|---|
| MsgA-PUSCH-Config-r16 ::= | SEQUENCE { |
| msgA-PUSCH-ResourceGroupA-r16 | MsgA-PUSCH- |
| Resource-r16 | OPTIONAL, -- |

Cond InitialBWPConfig

| | |
|---|---|
| msgA-PUSCH-ResourceGroupB-r16 | MsgA-PUSCH- |
| Resource-r16 | OPTIONAL, -- |

Cond GroupBConfigured

| | |
|---|---|
| msgA-TransformPrecoder-r16 | ENUMERATED |
| {enabled, disabled} | OPTIONAL, -- Need |

R

| | |
|---|---|
| msgA-DataScramblingIndex-r16 | INTEGER (0..1023) |

OPTIONAL, -- Need S

| | |
|---|---|
| msgA-DeltaPreamble-r16 | INTEGER (−1..6) |

OPTIONAL -- Need R
}

| | |
|---|---|
| MsgA-PUSCH-Resource-r16 ::= | SEQUENCE { |
| msgA-MCS-r16 | INTEGER |

(0..15),

| | |
|---|---|
| nrofSlotsMsgA-PUSCH-r16 | INTEGER (1..4), |
| nrofMsgA-PO-PerSlot-r16 | ENUMERATED |

{one, two, three, six},

| | |
|---|---|
| msgA-PUSCH-TimeDomainOffset-r16 | INTEGER (1..32), |
| msgA-PUSCH-TimeDomainAllocation-r16 | INTEGER |
| (1..maxNrofUL-Allocations) | OPTIONAL, -- |

Need S

| | |
|---|---|
| startSymbolAndLengthMsgA-PO-r16 | INTEGER (0..127) |

OPTIONAL, -- Need S

| | |
|---|---|
| mappingTypeMsgA-PUSCH-r16 | ENUMERATED |
| {typeA, typeB} | OPTIONAL, -- |

Need S

| | |
|---|---|
| guardPeriodMsgA-PUSCH-r16 | INTEGER (0..3) |

OPTIONAL, -- Need R

| | |
|---|---|
| guardBandMsgA-PUSCH-r16 | INTEGER (0..1), |
| frequencyStartMsgA-PUSCH-r16 | INTEGER |

(0..maxNrofPhysicalResourceBlocks-1),

| | |
|---|---|
| nrofPRBs-PerMsgA-PO-r16 | INTEGER (1..32), |
| nrofMsgA-PO-FDM-r16 | ENUMERATED |

{one, two, four, eight},

| | |
|---|---|
| msgA-IntraSlotFrequencyHopping-r16 | ENUMERATED |
| {enabled} | OPTIONAL, -- |

Need R

| | |
|---|---|
| msgA-HoppingBits-r16 | BIT STRING |

(SIZE(2))
OPTIONAL, -- Cond FreqHopConfigured

| | |
|---|---|
| msgA-DMRS-Config-r16 | MsgA-DMRS- |

Config-r16,

| | |
|---|---|
| nrofDMRS-Sequences-r16 | INTEGER (1..2), |
| msgA-Alpha-r16 | ENUMERATED |

{alpha0, alpha04, alpha05, alpha06,

| | |
|---|---|
| alpha07, alpha08, alpha09, alpha1} | OPTIONAL, -- Need S |
| interlaceIndexFirstPO-MsgA-PUSCH-r16 | INTEGER (1..10) |

OPTIONAL, -- Need R

| | |
|---|---|
| nrofInterlacesPerMsgA-PO-r16 | INTEGER (1..10) |

OPTIONAL, -- Need R
...
}

| | |
|---|---|
| MsgA-DMRS-Config-r16 ::= | SEQUENCE { |
| msgA-DMRS-AdditionalPosition-r16 | ENUMERATED |
| {pos0, pos1, pos3} | OPTIONAL, -- Need |

S

| | |
|---|---|
| msgA-MaxLength-r16 | ENUMERATED |
| {len2} | OPTIONAL, -- |

Need S

| | |
|---|---|
| msgA-PUSCH-DMRS-CDM-Group-r16 | INTEGER |
| (0..1) | OPTIONAL, -- |

Need S

| | |
|---|---|
| msgA-PUSCH-NrofPorts-r16 | INTEGER (0..1) |

OPTIONAL, -- Need S

| | |
|---|---|
| msgA-ScramblingID0-r16 | INTEGER |
| (0..65535) | OPTIONAL, -- |

Need S

| | |
|---|---|
| msgA-ScramblingID1-r16 | INTEGER |
| (0..65535) | OPTIONAL -- |

Need S
}

msgA-DataScramblingIndex
Identifier used to initiate data scrambling (c_init) for msgA PUSCH. If the field
is absent the UE applies the value Physical cell ID (physCellID).
msgA-DeltaPreamble
Power offset of msgA PUSCH relative to the preamble received target power.
Actual value = field value * 2 [dB] (see TS 38.213 [13], clause 7.1).
msgA-PUSCH-ResourceGroupA
MsgA PUSCH resources that the UE shall use when performing MsgA
transmission using preambles group A. If field is not configured for the selected
UL BWP, the UE shall use the MsgA PUSCH configuration for group A of
initial UL BWP.
msgA-PUSCH-ResourceGroupB
MsgA PUSCH resources that the UE shall use when performing MsgA
transmission using preambles group B.
msgA-TransformPrecoder
Enables or disables the transform precoder for MsgA transmission (see clause
6.1.3 of TS 38.214 [19]).
MsgA-PUSCH-Resource field descriptions
guardBandMsgA-PUSCH
PRB-level guard band between FDMed PUSCH occasions (see TS 38.213
[13], clause 8.1A). If interlaced PUSCH is configured, value 0 is applied.
guardPeriodMsgA-PUSCH
Guard period between PUSCH occasions in the unit of symbols (see TS
38.213 [13], clause 8.1A).
frequencyStartMsgA-PUSCH
Offset of lowest PUSCH occasion in frequency domain with respect to PRB 0
(see TS 38.213 [13], clause 8.1A).
interlaceIndexFirstPO-MsgA-PUSCH
Interlace index of the first PUSCH occasion in frequency domain if interlaced
PUSCH is configured. For 30 kHz SCS only the integers 1, 2, 3, 4, 5 are
applicable (see TS 38.213 [13], clause 8.1A).
mappingTypeMsgA-PUSCH
PUSCH mapping type A or B. If the field is absent, the UE shall use the
parameter msgA-PUSCH-TimeDomainAllocation (see TS 38.213 [13], clause
8.1A).
msgA-Alpha
Dedicated alpha value for MsgA PUSCH. If the field is absent, the UE shall
use the value of msg3-Alpha if configured, else UE applies value 1 (see TS
38.213 [13], clause 7.1.1).
msgA-DMRS-Config
DMRS configuration for msgA PUSCH (see TS 38.213 [13], clause 8.1A and
TS 38.214 [19] clause 6.2.2).
msgA-HoppingBits
Value of hopping bits to indicate which frequency offset to be used for second
hop. See Table 8.3-1 in TS 38.213 [13].
msgA-IntraSlotFrequencyHopping
Intra-slot frequency hopping per PUSCH occasion (see TS 38.213 [13], clause
8.1A).
msgA-MCS
Indicates the MCS index for msgA PUSCH from the Table 6.1.4.1-1 for DFT-
s-OFDM and Table 5.1.3.1-1 for CP-OFDM in TS 38.214 [19].
msgA-PUSCH-TimeDomainAllocation
Indicates a combination of start symbol and length and PUSCH mapping type
from the TDRA table (PUSCH-TimeDomainResourceAllocationList if
provided in PUSCH-ConfigCommon, or else the default Table 6.1.2.1.1-2 in
38.214 [19] is used if pusch-TimeDomainAllocationList is not provided in
PUSCH-ConfigCommon). The parameter K2 in the table is not used for msgA
PUSCH. The network configures one of msgA-PUSCH-
TimeDomainAllocation and startSymbolAndLengthMsgA-PO, but not both. If
the field is absent, the UE shall use the value of
startSymbolAndLenghtMsgA-PO.
msgA-PUSCH-TimeDomainOffset
A single time offset with respect to the start of each PRACH slot (with at least
one valid RO), counted as the number of slots (based on the numerology of
active UL BWP). See TS 38.213 [13], clause 8.1A.
nrofDMRS-Sequences
Number of DMRS sequences for MsgA PUSCH for CP-OFDM. In case of
single PUSCH configuration or if the DMRS symbols of multiple
configurations are not overlapped, if the DMRS resources configured in one
PUSCH occasion is no larger than 8 (for len2) or 4 (for len1), then only
DMRS port is configured.
nrofInterlacesPerMsgA-PO
Number of consecutive interlaces per PUSCH occasion if interlaced PUSCH
is configured. For 30 kHz SCS only the integers 1, 2, 3, 4, 5 are applicable (see
TS 38.213 [13], clause 8.1A).
nrofMsgA-PO-FDM
The number of msgA PUSCH occasions FDMed in one time instance (see TS
38.213 [13], clause 8.1A).
nrofMsgA-PO-PerSlot
Number of time domain PUSCH occasions in each slot. PUSCH occasions
including guard period are contiguous in time domain within a slot (see TS
38.213 [13], clause 8.1A).
nrofPRBs-PerMsgA-PO
Number of PRBs per PUSCH occasion (see TS 38.213 [13], clause 8.1A).
nrofSlotsMsgA-PUSCH
Number of slots (in active UL BWP numerology) containing one or multiple
PUSCH occasions, each slot has the same time domain resource allocation
(see TS 38.213 [13], clause 8.1A).
startSymbolAndLengthMsgA-PO
An index giving valid combinations of start symbol, length and mapping type
as start and length indicator (SLIV) for the first msgA PUSCH occasion, for
RRC_CONNECTED UEs in non-initial BWP as described in TS 38.214 [19]
clause 6.1.2. The network configures the field so that the allocation does not
cross the slot boundary. The number of occupied symbols excludes the guard
period. If the field is absent, the UE shall use the value in msgA-PUSCH-
TimeDomainAllocation (see TS 38.213 [13], clause 8.1A). The network
configures one of msgA-PUSCH-TimeDomainAllocation and
startSymbolAndLengthMsgA-PO, but not both. If the field is absent, the UE
shall use the value of msgA-PUSCH-TimeDomainAllocation.
MsgA-DMRS-Config field descriptions
msgA-DMRS-AdditionalPosition
Indicates the position for additional DM-RS. If the field is absent, the UE
applies value pos2.
msgA-MaxLength
indicates single-symbol or double-symbol DMRS. If the field is absent, the
UE applies value len1.
msgA-PUSCH-DMRS-CDM-Group
1-bit indication of indices of CDM group(s). If the field is absent, then both
CDM groups are used.
msgA-PUSCH-NrofPorts
0 indicates 1 port per CDM group, 1 indicates 2 ports per CDM group. If the
field is absent then 4 ports per CDM group are used (see TS 38.213 [13],
clause 8.1A).
msgA-ScramblingID0
UL DMRS scrambling initialization for CP-OFDM. If the field is absent the
UE applies the value Physical cell ID (physCellID).
msgA-ScramblingID1
UL DMRS scrambling initialization for CP-OFDM. If the field is absent the
UE applies the value Physical cell ID (physCellID).

Referring to Table 3, MsgA-PUSCH-Config includes an msgA-TransformPrecoder parameter.

Referring to Table 4, PUSCH-Config includes a transformPrecoder parameter.

The contents (the uplink channel structure, the uplink transmission/reception operation, and the Transform Precoder related configuration (Tables 2 to 4), etc.) described above may be applied in combination with methods proposed by the present disclosure to be described below or may be supplemented to clarify technical features of the methods proposed in the present disclosure. Methods to be described below are just distinguished for convenience and it is needless to say that some components of any one method may be substituted with some components of another method or may be applied in combination with each other.

Dynamic waveform switching (DWS) may be supported for coverage enhancement in NR. Hereinafter, a method for configuring a UL waveform of a UE according to a DCI format type and a situation when an indication field for the DWS is supported will be specifically described.

In a current NR, which waveform of CP-OFDM and DFT-S-OFDM is to be used is defined to be indicated through RRC signaling (e.g., SIBI, UE specific RRC signaling, etc.).

Specifically, in a 4-step RACH procedure, a waveform of an Msg. 3 PUSCH may be configured/indicated/determined as follows.

When the “msg3-transformPrecoder” is configured/indicated to be enabled (that is, when the UE receives a configuration including the msg3-transformPrecoder parameter (e.g., RACH-ConfigCommon in Table 2) from the base station), the transform precoder for Msg3 transmission is enabled. In other words, transform precoding for transmitting an Msg. 3 PUSCH is enabled. In this case, the UE uses the DFT-S-OFDM as a waveform of the Msg. 3 PUSCH.

When the “msg3-transformPrecoder” parameter field is empty (that is, when the UE receives a configuration without the msg3-transformPrecoder parameter (e.g., RACH-ConfigCommon in Table 2) from the base station, a transform precoder for Msg3 transmission is disabled. In other words, the transform precoding for transmitting the Msg. 3 PUSCH is disabled. In this case, the UE uses the CF-OFDM as the waveform of the Msg. 3 PUSCH.

In the case of a 2-step RACH procedure, a waveform of an MsgA PUSCH may be configured/indicated/determined as follows.

When the “msgA-TransformPrecoder” is configured/indicated to be enabled (that is, when the UE receives a configuration including the msgA-TransformPrecoder parameter configured to be ‘enabled’ (e.g., MsgA-PUSCH-Config in Table 3) from the base station), a transform precoder for MsgA transmission is enabled. In other words, transform precoding for transmitting an MsgA PUSCH is enabled. In this case, the UE uses the DFT-S-OFDM as a waveform of the MsgA PUSCH.

When the “msgA-TransformPrecoder” is configured/indicated to be disabled (that is, when the UE receives a configuration including the msgA-TransformPrecoder parameter configured to be ‘disabled’ (e.g., MsgA-PUSCH-Config in Table 3) from the base station), a transform precoder for MsgA transmission is disabled. In other words, transform precoding for transmitting the MsgA PUSCH is disabled. In this case, the UE uses the CP-OFDM as the waveform of the MsgA PUSCH.

Other UL channels other than the Msg. 3 PUSCH and Msg. A PUSCH (e.g., normal PUSCH, configured PUSCH, etc.) may be configured/indicated/determined as follows.

When the “transformPrecoder” is configured/indicated to be enabled (that is, when the UE receives a configuration including the transformPrecoder parameter configured to be ‘enabled’ (e.g., PUSCH-Config in Table 4) from the base station), a transform precoder for transmitting the other UL channel (e.g., PUSCH) is enabled. In other words, transform precoding for transmitting the other UL channel (e.g., PUSCH) is enabled. In this case, the UE uses the DFT-S-OFDM as a waveform of the other UL channel (e.g., PUSCH).

When the “transformPrecoder” is configured/indicated to be disabled (that is, when the UE receives a configuration including the transformPrecoder parameter configured to be ‘disabled’ (e.g., PUSCH-Config in Table 4) from the base station), the transform precoder for transmitting the other UL channel (e.g., PUSCH) is disabled. In other words, transform precoding for transmitting the other UL channel (e.g., PUSCH) is disabled. In this case, the UE uses the CP-OFDM as the waveform of the other UL channel (e.g., PUSCH).

Further, when the corresponding “transformPrecoder” parameter is not separately indicated, the UE operates according to the configuration of “msg3-transformPrecother”. Transform precoding is applied or not applied based on the configuration (enabled or disabled) of msgA-TransformPrecoder. In other words, whether transform precoding is applied to uplink transmission may be determined based on the configuration (enabled or disabled) of the msgA-TransformPrecoder.

Meanwhile, the dynamic waveform switching operation is considered for UL coverage enhancement of an existing NR system. Thus, when an explicit filed of N bits (e.g., N=1) for dynamic waveform switching is introduced, a UE/base station operation related to corresponding field needs to be additionally defined.

The present disclosure proposes a method for configuring a UL waveform of a UE according to a DCI format type and a situation when an indication field for dynamic waveform switching is supported.

### Method 1.1

Hereinafter, the method for configuring the UL waveform of the UE according to the DC format type and the situation when the indication field for the dynamic waveform switching is supported will be specifically described.

According to an embodiment, an N-bit indication field (e.g. N=1) for indicating dynamic waveform switching may be explicitly introduced into the DCI. In other words, a method for reinterpreting an existing DCI field for indicating the dynamic waveform switching or differently configuring a DCI field according to an UL waveform may be considered. Unlike the above-described method (DCI field reinterpretation/DCI field is configured differently), the embodiment introduces an N-bit indication field (e.g. N=1) dedicated to a cell supporting the dynamic waveform switching is introduced. That is, a change of the UL waveform (or a state of the UL waveform) may be performed based on an N-bit indication field newly added to/defined in the DCI. The embodiment may be extended to a method for introducing an explicit indication field that is not present in related art and changing the UL waveform through the bit value of the indication field.

Dynamic waveform switching (DWS) may be indicated based on PUSCH-Config which the base station may configure for each BWP. Specifically, the dynamic waveform switching (DWS) may be indicated based on the RRC parameter within the PUSCH-Config. The RRC parameter may be i) an existing parameter included in the PUSCH-Config, or ii) a parameter newly defined in/added to the PUSCH-Config (e.g., dynamicTransformPrecoderlndicationDCI).

Whether the N-bit indication field is present within the DCI may be indicated based on a value of the corresponding RRC parameter. The UE may determine that the dynamic waveform switching is enabled in the BWP based on the RRC parameter within the PUSCH-config. The UE may then determine that the transmitted DCI includes a field configuration (N-bit indication field) for the dynamic waveform switching. Hereinafter, specific examples will be described.

As an example, the value of the RRC parameter may be ‘enabled’, ‘dynamic’, or ‘dynamic switching’. 1) When the UE receives the PUSCH-Config including the RRC parameter, the UE may expect the N-bit indication field to be included within the DCI. The UE may determine whether to apply transform precoding based on the N-bit indication field. 2) When the UE receives PUSCH-Config in which the RRC parameter is absent, the UE may not expect the N-bit indication field to be included within the DCI. That is, in this case, an existing operation other than the DWS may be performed. Specifically, the UE may determine whether to apply the transform precoding based on the ‘transformPrecoder’ parameter.

As an example, the value of the RRC parameter may be ‘enabled’ or ‘disabled’. The UE may receive the PUSCH-Config including the RRC parameter. 1) When the RRC parameter is configured to be ‘enabled’, the UE may expect the N-bit indication field to be included within the DCI. The UE may determine whether to apply the transform precoding based on the N-bit indication field. 2) When the RRC parameter is configured to be ‘disabled’, the UE may not expect the N-bit indication field to be included within the DCI. That is, in this case, an existing operation other than the DWS may be performed. Specifically, the UE may determine whether to apply the transform precoding based on the ‘transformPrecoder’ parameter.

The above-described indications related to the DWS may be defined only for a specific DCI format(s). As an example, the above-described RRC parameter may include i) an RRC parameter representing whether an N-bit indication field is present in DCI format 0_1 and/or ii) an RRC parameter representing whether the N-bit indication field is present in DCI format 0_2.

When an n N-bit indication field for indicating the waveform is present in DCI format 0_2/DCI format 0_1 (e.g. N=1), a waveform to be used by the UE for PUSCH transmission may be configured according to a value dynamically indicated by the base station.

Specifically, it may be determined that the N-bit indication field is present in DCI (e.g., DCI format 0_1 and/or DCI format 0_2) based on the RRC parameter value within the PUSCH-Config configured for each BWP. In this case, it may be assumed that the UE receives (or monitors) DCI format 0_2 or DCI format 0_1 in which the N-bit indication field (e.g., N=1) is present.

In this case, the UE may disregard a configuration/indication value (e.g., a waveform related configuration value or a transform Precoding/transformPrecoder related configuration value) based on parameters used for an initial access (e.g., SIB, parameters, “msg3-transformPrecoder”, and “msgA-TransformPrecoder”). The UE may transmit the PUSCH by using the waveform dynamically configured/indicated through the DCI. The UE may determine whether to apply the transform precoding for the PUSCH based on the N-bit indication field of the DCI.

On the other hand, it is necessary to define how the UE is to operate when receiving DCI in which the N-bit indication field is absent. Specifically, it may be determined that the N-bit indication field is present in the DCI (e.g., DCI format 0_1 and/or DCI format 0_2) based on the RRC parameter value within the PUSCH-Config configured for each BWP. In this case, it may be assumed that the UE receives (or monitors) a DCI format (e.g., DCI format 0_2 or DCI format 0_0) in which the N-bit indication field (e.g., N=1) is not present. In this case, it may be necessary to define which waveform the UE should use to transmit the PUSCH.

The UE may operate according to a setting/indication value (e.g., a waveform related configuration value or a transform Precoding/transformPrecoder related setting value) based on parameters used for an initial access (e.g., SIB, parameters. “msg3-transformPrecoder”, and “msgA-TransformPrecoder”). As an example, when the msg3-transformPrecoder parameter is set, the UE may apply the transform precoding for transmitting the PUSCH (that is, the waveform for the PUSCH is based on the DFT-S-OFDM). As an example, when the msg3-transformPrecoder parameter is not set, the UE may not apply the transform precoding to the transmission of the PUSCH (that is, the waveform for the PUSCH is based on the CP-OFDM).

### Method 1.2

Hereinafter, a method for setting UL waveform values to be applied to DCI formats 0_0, 0_1, and 0_2, respectively in the dynamic waveform switching will be specifically described.

According to an embodiment, when receiving (monitoring) DCI format 0_2 or DCI format 0_0 in which the N-bit indication field (e.g., N=1) is absent, the UE may operate according to a setting/indication value (e.g., a waveform related setting value or a transform Precoding/transformPrecoder related setting value) based on parameters used for an initial access (e.g., SIB, parameters, “msg3-transformPrecoder”, and “msgA-TransformPrecoder”). As a specific example, a waveform (whether to apply the transform precoding) for the PUSCH transmission may be determined based on the msg3-transformPrecoder parameter or the msgA-TransformPrecoder parameter.

According to an embodiment, to DCI format 0_2 or DCI format 0_1 in which the N-bit indication field (e.g., N=1) is present, a waveform value set/indicated based on the indication field (e.g., a value representing enable/disable of the transform precoding) may be applied.

According to an embodiment, in the case of DCI format 0_2 or DCI format 0_1 in which the N-bit indication field (e.g., N=1) is present, a waveform value corresponding to the indication field may be indicated/determined by a fixed value. In other words, a waveform value which may be indicated through the indication field may be predefined. As an example, when a 1-bit explicit field with N=1 is introduced, a bit value of the indication field may be defined as follows.

“(transformPrecoder) enabled” (i.e., DFT-s-OFDM) may be defined to be mapped to a value of state 0 (or 1) of the bit field.

“(transformPrecoder) disabled” (i.e., CP-OFDM) may be defined to be mapped to a value of state 1 (or 0) of the bit field.

According to an embodiment, the waveform corresponding to the indication field may be configured/indicated through higher layer signaling or the like by the base station. Specifically, a value set by parameters (e.g., SIB, PUSCH-Config, RRC parameter) used for the existing waveform configuration by the base station may be defined to be mapped to state 0 (or 1) of the indication field. A remaining value may be defined to be mapped to state 1 (or 0) of the indication field. As a specific example, it may be assumed that transform precoding is configured to be disabled based on the higher layer signaling. In this case, the bit value ‘0’ (or ‘1’) of the indication field may indicate the disable of the transform precoding/transform precoder, and the bit value ‘1’ (or ‘0’) of the indicator field may indicate the enable of the transform precoding/transform precoder.

According to an embodiment, the base station may set/indicate a waveform value corresponding to state 0 (or state 1) of the indication field based on higher layer signaling (e.g., additional RRC parameter).

According to an embodiment, a value set/indicated based on the indication field may be applied to DCI format 0_2 or DCI format 0_1 in which the N-bit indication field (e.g., N=1) is present. In this case, a waveform to be applied according to a situation may be configured/defined in DCI format 0_2 or DCI format 0_0 in which the N-bit indication field (e.g., N=1) is not present. Hereinafter, this will be specifically described.

As an example, it may be assumed that i) the waveform corresponding to the indication field is indicated/determined based on a fixed value (e.g. enabled (or disabled)) or ii) a waveform corresponding state 0 or 1 of the indication field is configured via the additional RRC parameter (disregarding the RRC parameter used for the existing waveform configuration).

In this case, with respect to DCI format 0_2 or DCI format 0_0 in which the N-bit indication field (e.g., N=1) is not present, the UE may operate based on the waveform corresponding to the value of state 0 (or 1) of the indication field. Alternatively, the UE may not apply the waveform corresponding to the state 0 (or 1) value of the indication field configured/indicated through the DCI, but may apply the waveform indicated by the RRC parameter used for the existing waveform configuration.

As an example, with respect to DCI format 0_2 or DCI format 0_1 in which the N-bit indication field (e.g., N=1) is present, it may be assumed that state 0 (or 1) of the indication field is mapped to a value set by the existing RRC parameter. Specifically, state 0 (or 1) of the indication field may be mapped to the value (enabled or disabled) set by the RRC parameter (e.g. “transformPrecoder”) used for the existing waveform configuration, and state 1 (or 0) of the indication field may be mapped to a remaining value (disabled or enabled). In this case, when the UE receives DCI format 0_2 or DCI format 0_0 in which the N-bit indication field (e.g., N=1) is not present, the UE may operate as follows.

The UE may operate according to the state 0 (or 1) value of the indication field described above. Alternatively, the UE may not follow the state 0/1 of the indication field, but may follow the setting of the existing RRC parameter.

As a result, when the base station sets/indicates the additional RRC parameter for configuring the indication field to the UE, the UE may determine that the dynamic waveform switching is enabled, and may interpret/decode the DCI.

### Method 1.3

Hereinafter, a method for configuring an indication field for the dynamic waveform switching for DCI format 0_1 and DCI format 0_2 will be specifically described.

A method for the dynamic waveform switching for DCI format 0_1, and DCI format 0_2 in which the N-bit indication field (e.g., N=1) is present in introducing an indication field configuration is proposed.

According to an embodiment, in the case of DCI format 0_1, and DCI format 0_2 in which the N-bit indication field (e.g., N=1) is present, one indication field setting method and a method for applying/using the setting value may be defined for all DCI formats (i.e., DCI format 0_1 and DCI format 0_2). That is, for each of all DCI formats in which the indication field is present, the UE may interpret the value of the indication field to be the same and apply the interpreted value in the same scheme. In respective indication fields of all DCI formats, whether to apply a configuration/waveform/transform precoding indicated based on the value of the same indication field may be the same. As a specific example, the value ‘0’ (or ‘1’) of the indication field of each of DCI format 0_1 and DC format 0_2 may indicate enable (or disable) of the transform precoding/transform precoder.

That is, a value of an indication field of DCI format 0_1 and a value of an indicator field of DCI form 0_2 may be equally defined as a promised fixed value (e.g., ‘enabled (or disabled)’).

As another example, the state 0 (or 1) value of the indication field may also be defined to follow a value defined by an existing RRC parameter. Alternatively, the value of the indication field may also be set through an additional RRC parameter.

According to an embodiment, the indication field value in DCI format 0_1 and the indication field value of DCI format 0_2 may also be set independently of each other. In this case, when the base station does not provide the indication field setting value, the following UE operations may be defined.

As an example, it may be assumed that the base station defines a setting for the indication field via the additional RRC parameter, but a setting value for DCI format 0_1 is given, while no separate setting value for DCI format 02 is provided.

In this case, the UE may operate by interpreting that the indication field setting value for DCI format 0_2 is the same as the indication field setting value for DCI form 0_1.

Alternatively, the UE may operate by assuming that the state 0 (or state 1) value of the indication field for DCI format 0_2 is set based on the existing RRC parameter value.

As another example, it may be assumed that the base station defines the setting for the indication field via the additional RRC parameter, but a separate setting value for DCI format 0_1 and/or DCI format 0_2 is not provided.

The UE may operate by assuming that the state 0 (or state 1) value of the indication field for DCI format 0_1 and/or DCI format 0_2 is set based on the existing RRC parameter value.

The embodiments based on Methods 1.1 to 1.3 proposed above may be configured/applied to other UL signals/channels such as MSG3 PUSCH, MSGA Preamble/PUSCH, and/or PUSCH/PUCCH. Further, it is obvious that since the examples of the proposed scheme described above may also be included as one of implementing methods of the present disclosure, the examples may be regarded as a kind of proposed schemes. Further, the proposed schemes described above may be independently implemented, but implemented in combination (or merge) of some of the proposed schemes. A rule is defined so that the base station notifies, to the UE, information regarding whether to apply the proposed methods (or information on rules of the proposed methods) through a signal (e.g., a physical layer signal or a higher layer signal) defined in advance. A higher layer may include, for example, one or more of functional layers such as MAC, RLC, RRC, and SDAP.

The methods, embodiments or descriptions for implementing the method proposed in the present disclosure may be applied separately, or one or more methods (or embodiments or descriptions) may be applied in combination.

As an example, the operations based on at least one of Methods 1.1 to 1.3 may be based on Table 5 below.

TABLE 5
6.1.3 UE procedure for applying transform precoding on PUSCH
For a PUSCH scheduled by RAR UL grant, or for a PUSCH scheduled by
fallbackRAR UL grant, or for a PUSCH scheduled by DCI format 0_0 with CRC
scrambled by TC-RNTI, the UE shall consider the transform precoding either
′enabled′ or ′disabled′ according to the higher layer configured parameter msg3-
transformPrecoder.
For a MsgA PUSCH, the UE shall consider the transform precoding either
′enabled′ or ′disabled′ according to the higher layer configured parameter msgA-
TransformPrecoder. If higher layer parameter msgA-TransformPrecoder is not
configured, the UE shall consider the transform precoding either ′enabled′ or
′disabled′ according to the higher layer configured parameter msg3-
transformPrecoder.
For PUSCH transmission scheduled by a PDCCH with CRC scrambled by CS-
RNTI with NDI=1, C-RNTI, or MCS-C-RNTI or SP-CSI-RNTI:
- If the DCI with the scheduling grant was received with DCI format 0_0,
the UE shall, for this PUSCH transmission, consider the transform precoding
either enabled or disabled according to the higher layer configured parameter
msg3-transformPrecoder.
- If the DCI with the scheduling grant was not received with DCI format
0_0
- If the DCI with the scheduling grant was received with DCI format 0_1 or
0_2 with CRC scrambled by C-RNTI, MCS-RNTI, or CS-RNTI with NDI=1 and
if the UE is configured with a higher layer parameter
[dynamicTransformPrecoderIndicationDCI-0-1] in pusch-Config for DCI format
0_1 or [dynamicTransformPrecoderIndicationDCI-0-2] in pusch-Config for DCI
format 0_2 and the higher layer parameter is set to ‘enabled’,
- the UE shall, for this PUSCH transmission, consider the transform
precoding either enabled or disabled according to the Transform precoder
indicator field in the DCI with the scheduling grant.
- For pusch-TimeDomainAllocationListForMultiPUSCH in pusch-Config.
the UE shall, for all PUSCH transmissions, consider the transform precoding
either enabled or disabled according to Transform precoder indicator field in the
DCI format 0_1 with the scheduling grant.
- If resourceAllocation in pusch-Config for DCI format 0_1 or
resourceAllocationDCI-0-2 in pusch-Config for DCI format 0_2 is set to
resourceAllocationType0, or if the resource allocation is set to resource allocation
type 0 according to the DCI configuration as described in clauses 7.3.1.1.2 and
7.3.1.1.3 of [6, TS 38.212], or if dmrs-Type in DMRS-UplinkConfig is set to ‘type
2’ for this PUSCH transmission, the UE does not expect that the Transform
precoder indicator field in the DCI with the scheduling grant indicates that
transform precoding is enabled.
- If the UE is configured with the higher layer parameter enhanced-dmrs-
Type-r18 in DMRS-UplinkConfig, and if the scheduling grant indicates that
transform precoding is enabled for the scheduled PUSCH transmission, the UE
ignores the higher layer parameters enhanced-dmrs-Type-r18 in DMRS-
UplinkConfig, if configured, for the DM-RS transmission of the scheduled
PUSCH transmission.
- Otherwise,
- If the UE is configured with the higher layer parameter
transformPrecoder in pusch-Config, the UE shall, for this PUSCH transmission,
consider the transform precoding either enabled or disabled according to this
parameter.
- If the UE is not configured with the higher layer parameter
transformPrecoder in pusch-Config, the UE shall, for this PUSCH transmission,
consider the transform precoding either enabled or disabled according to the
higher layer configured parameter msg3-transformPrecoder.
For PUSCH transmission with a configured grant
- If the UE is configured with the higher layer parameter
transformPrecoder in configuredGrantConfig, the UE shall, for this PUSCH
transmission, consider the transform precoding either enabled or disabled
according to this parameter.
- If the UE is not configured with the higher layer parameter
transformPrecoder in configuredGrantConfig, the UE shall, for this PUSCH
transmission, consider the transform precoding either enabled or disabled
according to the higher layer configured parameter msg3-transformPrecoder.

As an example, the DCI format including the N-bit indication field based on at least one of Methods 1.1 to 1.3 may be based on Table 6 below.

TABLE 6
7.3.1.1.2Format 0_1
DCI format 0_1 is used for the scheduling of one or multiple PUSCH in one cell,
or indicating CG downlink feedback information (CG-DFI) to a UE.
The following information is transmitted by means of the DCI format 0_1 with
CRC scrambled by C-RNTI or CS-RNTI or SP-CSI-RNTI or MCS-C-RNTI:
- Transform precoder indicator - 0 or 1 bit
- 1 bit if the higher layer parameter
dynamicTransformPrecoderIndicationDCI-0-1 is configured to ‘enabled ’ and if
the UE is configured to monitor DCI format 0_1 with CRC scrambled by C-RNTI
or CS-RNTI or MCS-C-RNTI, where the bit value of 0 indicates that transform
precoder is enabled and the bit value of 1 indicates that transform precoder is
disabled. For a DCI format 0_1 with CRC scrambled by CS-RNTI and the value
indicated by new data indicator field is 0, or for a DCI format 0_1 with CRC
scrambled by SP-CSI-RNTI, the bit is reserved.
- 0 bit otherwise.
7.3.1.1.3 Format 0 2
DCI format 0_2 is used for the scheduling of PUSCH in one cell.
The following information is transmitted by means of the DCI format 0_2 with
CRC scrambled by C-RNTI or CS-RNTI or SP-CSI-RNTI or MCS-C-RNTI:
- Transform precoder indicator - 0 or 1 bit
- 1 bit if the higher layer parameter
dynamicTransformPrecoderIndicationDCI-0-2 is configured to ‘enabled ’ and if
the UE is configured to monitor DCI format 0_2 with CRC scrambled by C-RNTI
or CS-RNTI or MCS-C-RNTI, where the bit value of 0 indicates that transform
precoder is enabled and the bit value of 1 indicates that transform precoder is
disabled. For a DCI format 0_2 with CRC scrambled by CS-RNTI and the value
indicated by new data indicator field is 0, or for a DCI format 0 2 with CRC
scrambled by SP-CSI-RNTI, the bit is reserved.
- 0 bit otherwise.

The transform precoder indicator field in Table 6 may mean an (N-bit) indication field based on at least one of Methods 1.1 to 1.3.

In terms of implementation, the operations (e.g., operations based on at least one of Methods 1.1 to 1.3) of the BS/UE according to the above-described embodiments may be processed by devices (e.g., 100 and 200) in FIG. 4 to be described below.

Further, the operations (e.g., operations based on at least one of Methods 1.1 to 1.3) of the base station/UE according to the above-described embodiment may be stored in memories (e.g., 140 and 240 in FIG. 4) in the form of an instruction/program (e.g., instruction or executable code) for driving at least one processor (e.g., 110 and 210 in FIG. 4).

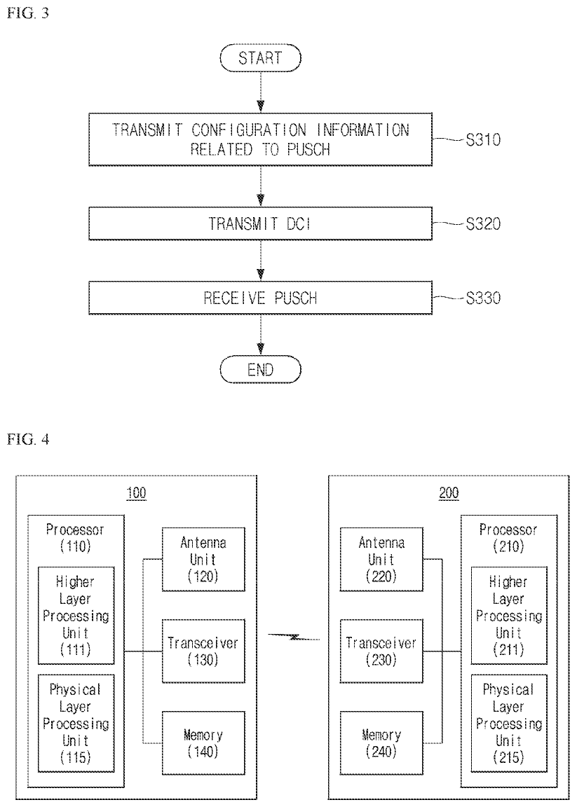

Hereinafter, the embodiments described above will be described in detail with reference to FIGS. 2 and 3 in terms of the operations of the UE and the base station. Methods to be described below are just distinguished for convenience and it is needless to say that some components of any one method may be substituted with some components of another method or may be applied in combination with each other.

FIG. 2 is a flowchart for describing a method performed by a user equipment (UE) according to an embodiment of the present disclosure.

Referring to FIG. 2, the method performed by the UE according to an embodiment of the present disclosure includes a step S210 of receiving configuration information related to a PUSCH, a step S220 of receiving DCI, and a step S230 of transmitting the PUSCH.

In S210, the UE receives, from the base station, configuration information related to a Physical Uplink Channel (PUSCH).

The configuration information may be based on PUSCH-config. The configuration information may include information based on Methods 1.1 to 1.3 described above. As an example, the configuration information may include a parameter related to a dynamic indication of transform precoding (e.g., dynamicTransformPrecoderlndication in Table 5).

In S220, the UE receives, from the base station, Downlink Control Information (DCI) for scheduling the PUSCH.

The DCI format related to the DCI may be DCI format 0_0, DCI format 0_1, or DCI format 0_2.

Whether transform precoding for the PUSCH is enabled may be determined based on at least one of Methods 1.1 to 1.3 described above.

Specifically, based on the DCI format related to the DCI and/or the configuration information, whether the transform precoding for the PUSCH is enabled may be determined based on the DCI or a higher layer parameter.

As an example, based on the DCI format being the DCI format 0_1 or the DCI format 0_2, and a parameter related to a dynamic indication of the transform precoding being configured based on the configuration information:

the DCI may include a transform precoder indicator field. The transform precoding may be enabled or disabled based on the transform precoder indicator field.

As an example, based on the DCI format being the DCI format 0_1 or the DCI format 0_2, and the parameter related to the dynamic indication not being configured based on the configuration information: the transform precoding may be enabled or disabled based on the higher layer parameter.

The higher layer parameter is a transformPrecoder parameter within the configuration information or a random access parameter.

Based on the transformPrecoder parameter not being configured: the transform precoding may be enabled or disabled based on the random access parameter.

The random access parameter is an msg3-transformPrecoder parameter.

As an example, based on the DCI format being a DCI format 0_0, the transform precoding may be enabled or disabled based on the higher layer parameter (e.g., msg3-transformPrecoder parameter).

According to an embodiment, based on a txConfig parameter representing a transmission scheme related to the PUSCH not being configured, the DCI format may be the DCI format 0_0. In this case, the PUSCH may be transmitted based on a single antenna port. For example, the configuration information may not include the txConfig parameter.

According to an embodiment, based on the txConfig parameter representing the transmission scheme related to the PUSCH being configured, the DCI format may be the DCI format 0_1 or the DCI format 0_2.

The transmission scheme may be codebook based transmission or non-codebook based transmission. In this case, the PUSCH may be transmitted based on the same antenna ports as one or more SRS ports indicated based on the DCI format. The one or more SRS ports may be based on one or more SRS resources indicated based on an SRS resource indicator field of the DCI format.

According to an embodiment, a waveform related to the transmission of the PUSCH may be based on i) Cyclic Prefix-Orthogonal Frequency Division Multiplexing (CP-OFDM) or ii) Discrete Fourier Transform-Spreading-OFDM (DFT-S-OFDM), the transform precoding may be related to the DFT-S-OFDM.

According to an embodiment, physical Uplink Control Information (UCI) may be multiplexed in the PUSCH in which the transform precoding is enabled based on the transform precoder indicator field. In this case, the UCI may be related to a PUCCH format to which the transform precoding is applied.

Specifically, a Physical Uplink Control CHannel (PUCCH) format related to the UCI may be PUCCH format 3 or PUCCH format 4 (see Table 1). The transform precoding may be applied to the PUCCH format 3 or the PUCCH format 4.

In S230, the UE transmits the PUSCH to the base station.

The method may further include a random access configuration receiving step. In the random access configuration receiving step, the UE receives a Random Access Channel (RACH) configuration from the base station. The RACH configuration may be based on RACH-ConfigCommon in Table 2. The higher layer parameter may include an msg3-transformPrecoder parameter within the RACH configuration.

The method may further include a PUCCH transmitting step. In the PUCCH transmitting step, the UE transmits a Physical Uplink Control Channel (PUCCH) to the base station. The PUSCH and the PUCCH may be transmitted simultaneously.

In this case, whether a waveform related to the PUSCH (whether transform precoding is applied) may be the same as or different from a waveform related to the PUCCH (whether the transform precoding is applied). That is, the simultaneous transmission may be performed based on the same waveform or different waveforms.

As an example, the waveform related to the PUSCH (e.g., CP-OFDM or DFT-S-OFDM) may be the same as the waveform related to the PUCCH (e.g., CP-OFDM or DFT-S-OFDM). As an example, the waveform related to the PUSCH (e.g., CP-OFDM or DFT-S-OFDM) may be different from the waveform related to the PUCCH (e.g., CP-OFDM or DFT-S-OFDM).

The operations based on S210 to S230, the random access configuration receiving step, and the PUCCH transmitting step described above may be implemented by the devices in FIG. 4. For example, a UE 200 may control one or more transceivers 230 and/or one or more memories 240 to perform the operations based on S210 to S230, the random access configuration receiving step, and the PUCCH transmitting step.

Hereinafter, the embodiments described below will be specifically described in terms of the operation of the base station.

S310 to S330, a random access configuration transmitting step, and a PUCCH receiving step described below correspond to S210 to S230, the random access configuration receiving step, and the PUCCH transmitting step described in FIG. 2. By considering the correspondence relationship, redundant descriptions are omitted. That is, a specific description of a base station operation described below may be replaced with the description/example of FIG. 2 corresponding to the operation. As an example, the description/embodiments of S210 to S230 in FIG. 2 may be additionally applied to base station operations of S310 to S330 described below. As an example, the description/embodiments of the random access configuration receiving step and the PUCCH transmitting step may be additionally applied to the base station operations of the random access configuration transmitting step and the PUCCH receiving step described below.

FIG. 3 is a flowchart for describing a method performed by a base station according to another embodiment of the present disclosure.

Referring to FIG. 3, the method performed by the base station according to an embodiment of the present disclosure includes a step S310 of transmitting configuration information related to a PUSCH, a step S320 of transmitting DCI, and a step S330 of receiving the PUSCH.

In S310, the base station transmits, to the UE, configuration information related to a Physical Uplink Channel (PUSCH).

In S320, the base station transmits, to the UE, Downlink Control Information (DCI) for scheduling the PUSCH.

In S330, the base station receives the PUSCH from the UE.

The method may further include a random access configuration transmitting step. In the random access configuration transmitting step, the base station transmits a Random Access CHannel (RACH) configuration to the UE.

The method may further include a PUCCH receiving step. In the PUCCH receiving step, the base station receives a Physical Uplink Control Channel (PUCCH) from the UE. The PUSCH and the PUCCH may be received simultaneously.

The operations based on 310 to S330, the random access configuration transmitting step, and the PUCCH receiving step described above may be implemented by the devices in FIG. 4. For example, a base station 100 may control one or more transceivers 130 and/or one or more memories 140 to perform the operations based on S310 to S330, the random access configuration transmitting step, and the PUCCH receiving step.

A device to which an embodiment of the present disclosure is applicable (a device implementing the method/operation according to an embodiment of the present disclosure) is described below with reference to FIG. 4.

FIG. 4 illustrates configuration of a first device and a second device according to an embodiment of the present disclosure.

A first device 100 may include a processor 110, an antenna unit 120, a transceiver 130, and a memory 140.

The processor 110 may perform baseband-related signal processing and include a higher layer processing unit 111 and a physical layer processing unit 115. The higher layer processing unit 111 may process operations of the MAC layer, the RRC layer, or higher layers. The physical layer processing unit 115 may process the operation of the PHY layer. For example, if the first device 100 is a base station (BS) device in BS-UE communication, the physical layer processing unit 115 may perform uplink reception signal processing, downlink transmission signal processing, and the like. For example, if the first device 100 is a first UE device in inter-UE communication, the physical layer processing unit 115 may performs downlink reception signal processing, uplink transmission signal processing, sidelink transmission signal processing, and the like. The processor 110 may control the overall operation of the first device 100 in addition to performing the baseband-related signal processing.

The antenna unit 120 may include one or more physical antennas and support MIMO transmission/reception if the antenna unit 120 includes a plurality of antennas. The transceiver 130 may include a radio frequency (RF) transmitter and an RF receiver. The memory 140 may store information processed by the processor 110 and software, operating systems, and applications related to the operation of the first device 100. The memory 140 may also include components such as a buffer.

The processor 110 of the first device 100 may be configured to implement the operation of the BS in the BS-UE communication (or the operation of the first UE device in the inter-UE communication) in embodiments described in the present disclosure.

The second device 200 may include a processor 210, an antenna unit 220, a transceiver 230, and a memory 240.

The processor 210 may perform baseband-related signal processing and include a higher layer processing unit 211 and a physical layer processing unit 215. The higher layer processing unit 211 may process the operation of the MAC layer, the RRC layer, or higher layers. The physical layer processing unit 215 may process the operation of the PHY layer. For example, if the second device 200 is a UE device in BS-UE communication, the physical layer processing unit 215 may perform downlink reception signal processing, uplink transmission signal processing, and the like. For example, if the second device 200 is a second UE device in inter-UE communication, the physical layer processing unit 215 may perform downlink reception signal processing, uplink transmission signal processing, sidelink reception signal processing, and the like. The processor 210 may control the overall operation of the second device 210 in addition to performing the baseband-related signal processing.

The antenna unit 220 may include one or more physical antennas and support MIMO transmission/reception if the antenna unit 220 includes a plurality of antennas. The transceiver 230 may include an RF transmitter and an RF receiver. The memory 240 may store information processed by the processor 210 and software, operating systems, and applications related to the operation of the second device 200. The memory 240 may also include components such as a buffer.

The processor 210 of the second device 200 may be configured to implement the operation of the UE in the BS-UE communication (or the operation of the second UE device in the inter-UE communication) in embodiments described in the present disclosure.

The descriptions for the BS and the UE in the BS-UE communication (or the first UE device and the second UE device in the inter-UE communication) in the examples of the present disclosure can be equally applied to the operations of the first device 100 and the second device 200, and redundant descriptions are omitted.

The wireless communication technology implemented in the devices 100 and 200 according to the present disclosure may further include narrowband Internet of Things (NB-IoT) for low-power communication in addition to LTE, NR, and 6G. For example, the NB-IoT technology may be an example of a low power wide area network (LPWAN) technology and may be implemented in standards such as LTE Cat NB1 and/or LTE Cat NB2. The NB-IoT technology is not limited to the above-described names.

Additionally or alternatively, the wireless communication technology implemented in the devices 100 and 200 according to the present disclosure may perform communication based on LTE-M technology. For example, the LTE-M technology may be an example of the LPWAN technology, and may be called by various names such as enhanced machine type communication (eMTC). For example, the LTE-M technology may be implemented with at least one of various standards such as 1) LTE CAT 0, 2) LTE Cat M1, 3) LTE Cat M2, 4) LTE non-BL (non-Bandwidth Limited), 5) LTE-MTC, 6) LTE machine type communication, and/or 7) LTE M. The LTE-M technology is not limited to the above-mentioned names.

Additionally or alternatively, the wireless communication technology implemented in the devices 100 and 200 according to the present disclosure may include at least one of ZigBee, Bluetooth, and low power wide area network (LPWAN) in consideration of low power communication, and is not limited to the above-mentioned names. For example, the ZigBee technology may create personal area networks (PAN) related to small/low-power digital communication based on various standards such as IEEE 802.15.4, and may be called by various names.

1. A method, performed by a user equipment (UE), comprising:
receiving configuration information related to a Physical Uplink Shared Channel (PUSCH);
receiving Downlink Control Information (DCI) for scheduling of the PUSCH; and
transmitting the PUSCH,
wherein, based on a DCI format related to the DCI and the configuration information: whether a transform precoding for the PUSCH is enabled is determined based on the DCI,
wherein, based on i) the DCI format being a DCI format 0_1 or a DCI format 0_2 and ii) a parameter related to a presence of a transform precoder indicator field in the DCI being configured based on the configuration information:
the DCI includes the transform precoder indicator field, and
the transform precoding is enabled or disabled based on the transform precoder indicator field.

2. The method of claim 1, wherein, based on at least one of i) the DCI format related to the DCI or ii) the configuration information: whether the transform precoding for the PUSCH is enabled is determined based on one of i) the DCI and ii) a higher layer parameter,
wherein, based on the DCI format being the DCI format 0_1 or the DCI format 0_2, and the parameter related to the presence of the transform precoder indicator field in the DCI not being configured based on the configuration information:
the transform precoding is enabled or disabled based on the higher layer parameter.

3. The method of claim 2, wherein the higher layer parameter is a transformPrecoder parameter within the configuration information or a random access parameter.

4. The method of claim 3, wherein based on the transformPrecoder parameter not being configured: the transform precoding is enabled or disabled based on the random access parameter.

5. The method of claim 4, wherein the random access parameter is an msg3-transformPrecoder parameter.

6. The method of claim 2, wherein based on the DCI format being a DCI format 0_0, the transform precoding is enabled or disabled based on the higher layer parameter.

7. The method of claim 6, wherein based on a txConfig parameter representing a transmission scheme related to the PUSCH not being configured, the DCI format is the DCI format 0_0.

8. The method of claim 7, wherein the PUSCH is transmitted based on a single antenna port.

9. The method of claim 1, wherein based on a txConfig parameter representing a transmission scheme related to the PUSCH being configured, the DCI format is the DCI format 01 or the DCI format 0_2.

10. The method of claim 9, wherein the transmission scheme is codebook based transmission or non-codebook based transmission.

11. The method of claim 10, wherein the PUSCH is transmitted based on same antenna ports as one or more SRS ports indicated based on the DCI format.

12. The method of claim 11, wherein the one or more SRS ports are based on one or more SRS resources indicated based on an SRS resource indicator field of the DCI format.

13. The method of claim 1, wherein a waveform related to the transmission of the PUSCH is based on i) Cyclic Prefix-Orthogonal Frequency Division Multiplexing (CP-OFDM) or ii) Discrete Fourier Transform-Spreading-OFDM (DFT-S-OFDM).

14. The method of claim 13, wherein the transform precoding is related to the DFT-S-OFDM.

15. The method of claim 1, wherein physical Uplink Control Information (UCI) is multiplexed in the PUSCH in which the transform precoding is enabled based on the transform precoder indicator field,
wherein a Physical Uplink Control Channel (PUCCH) format related to the UCI is PUCCH format 3 or PUCCH format 4, and
wherein the transform precoding is applied to the PUCCH format 3 or the PUCCH format 4.

16. The method of claim 1, further comprising:
transmitting a Physical Uplink Control Channel (PUCCH),
wherein the PUSCH and the PUCCH are transmitted simultaneously.

17. The method of claim 16, wherein a waveform related to the PUSCH is the same as a waveform related to the PUCCH.

18. The method of claim 16, wherein a waveform related to the PUSCH is different from the waveform related to the PUCCH.

19. A user equipment (UE) comprising:
one or more transceivers;
one or more processors; and
one or more memories connected to the one or more processors and storing instructions,
wherein the instructions configure the one or more processors to perform, based on being executed by the one or more processors, operations comprising:
receiving configuration information related to a Physical Uplink Shared Channel (PUSCH);
receiving Downlink Control Information (DCI) for scheduling of the PUSCH; and
transmitting the PUSCH,
wherein, based on a DCI format related to the DCI and the configuration information: whether a transform precoding for the PUSCH is enabled is determined based on the DCI,
wherein, based on i) the DCI format being a DCI format 0_1 or a DCI format 0_2 and ii) a parameter related to a presence of a transform precoder indicator field in the DCI being configured based on the configuration information:
the DCI includes the transform precoder indicator field, and
the transform precoding is enabled or disabled based on the transform precoder indicator field.

20-22. (canceled)

23. A base station comprising:
one or more transceivers;
one or more processors; and
one or more memories connected to the one or more processors and storing instructions,
wherein the instructions configure the one or more processors to perform, based on being executed by the one or more processors, operations comprising:
transmitting configuration information related to a Physical Uplink Shared Channel (PUSCH);
transmitting Downlink Control Information (DCI) for scheduling of the PUSCH; and
receiving the PUSCH,
wherein, based on a DCI format related to the DCI and the configuration information: whether a transform precoding for the PUSCH is enabled is determined based on the DCI,
wherein, based on i) the DCI format being a DCI format 0_1 or a DCI format 0_2 and ii) a parameter related to a presence of a transform precoder indicator field in the DCI being configured based on the configuration information:
the DCI includes the transform precoder indicator field, and
the transform precoding is enabled or disabled based on the transform precoder indicator field.

24. The method of claim 1, wherein, based on i) the DCI format being a DCI format 0_1 or a DCI format 0_2, ii) a parameter related to a presence of a transform precoder indicator field in the DCI being configured based on the configuration information, and iii) a new data indicator field of the DCI indicating new data:
the DCI includes the transform precoder indicator field, and
the transform precoding is enabled or disabled based on the transform precoder indicator field.

25. The UE of claim 19, wherein, based on i) the DCI format being a DCI format 0_1 or a DCI format 0_2, ii) a parameter related to a presence of a transform precoder indicator field in the DCI being configured based on the configuration information, and iii) a new data indicator field of the DCI indicating new data:
the DCI includes the transform precoder indicator field, and
the transform precoding is enabled or disabled based on the transform precoder indicator field.

26. The base station of claim 23, wherein, based on i) the DCI format being a DCI format 0_1 or a DCI format 0_2, ii) a parameter related to a presence of a transform precoder indicator field in the DCI being configured based on the configuration information, and iii) a new data indicator field of the DCI indicating new data:
the DCI includes the transform precoder indicator field, and
the transform precoding is enabled or disabled based on the transform precoder indicator field.
